(19) United States
(12) Patent Application Publication
(10) Pub. No.: US 2013/0089801 A1
(43) Pub. Date: Apr. 11, 2013

(54) FUEL CELL SYSTEM AND METHOD OF CONTROLLING FUEL CELL SYSTEM

(71) Applicants: Masahiro Takeshita, Toyota-shi (JP); Nobukazu Mizuno, Miyoshi-shi (JP)

(72) Inventors: Masahiro Takeshita, Toyota-shi (JP); Nobukazu Mizuno, Miyoshi-shi (JP)

(73) Assignee: TOYOTA JIDOSHA KABUSHIKI KAISHA, Toyota-shi (JP)

(21) Appl. No.: 13/703,258

(22) PCT Filed: May 31, 2011
(86) PCT No.: PCT/IB2011/001186

§ 371 Date: Dec. 10, 2012

(30) Foreign Application Priority Data
Jun. 17, 2010 (JP) 2010-138153

(51) Int. Cl. H01M 8/04

(52) U.S. Cl. CPC H01M 8/04104
USPC 429/446

(57) ABSTRACT

A fuel cell system is equipped with an airflow meter that measures an amount of a supplied cathode gas, and a hydrogen circulation pump. A controller instructs the fuel cell to perform a preset reference operation, measures the power consumed by the hydrogen circulation pump, and determines the amount of the supplied cathode gas appropriate for the amount of power consumed by the hydrogen circulation pump. The controller then calculates, the measurement error in the airflow meter and correction value for the measurement error. The controller controls the amount of the supplied cathode gas based on the value measured by the airflow meter after being corrected with the correction value.

### BACKGROUND OF THE INVENTION

1. Field of the Invention

This invention relates to a fuel cell.

2. Description of Related Art

A fuel cell system supplies reactant gases to a fuel cell to generate electricity, and outputs power corresponding to a request from an external load. Generally, in the fuel cell system, the flow rate of a cathode gas is measured by a flowmeter, such as an airflow meter, and the amount of the cathode gas supplied to the fuel cell is controlled based on the measured flow rate (see, e.g., Japanese Patent Application Publication No. 2007-220625 (JP-A-2007-220625)). However, the accuracy of the flowmeter deteriorates over time, which may introduce errors in measurement. When the reading from the flowmeter is erroneous, an inappropriate amount of the cathode gas may be supplied to the fuel cell.

### SUMMARY OF THE INVENTION

The invention facilitates the appropriate control the amounts of reactant gases supplied to a fuel cell.

As a first aspect of the invention, a fuel cell system that outputs a power in accordance with a request from an external load includes a fuel cell, a cathode gas supply portion that supplies a cathode gas to the fuel cell, a gas delivery amount sensor that measures an amount of the cathode gas delivered to the fuel cell by the cathode gas supply portion, an anode gas supply portion that supplies an anode gas to the fuel cell, a characteristic value detection portion that detects a characteristic value selected in advance as a value associated with the anode gas and correlated with an amount of the cathode gas actually supplied to the fuel cell, and a controller that controls an amount of the anode gas supplied to the fuel cell and an amount of the cathode gas supplied to the fuel cell to control operation of the fuel cell. The controller has stored therein in advance a correlation between an amount of the supplied cathode gas at a time when reference operation is performed to operate the fuel cell on a preset condition and the characteristic value. The controller causes the fuel cell to perform the reference operation, acquires a value measured by the gas delivery amount sensor, detects the characteristic value, acquires, as a supply amount reference value, the amount of the supplied cathode gas for the detected characteristic value using the correlation, and calculates, as an error in the value measured by the gas delivery amount sensor, a difference between the supply amount reference value and the value measured by the gas delivery amount sensor. The controller adjusts an amount of the cathode gas delivered by the cathode gas supply portion such that the error is compensated for in supplying the cathode gas to the fuel cell, on a basis of the value measured by the gas delivery amount sensor. According to the first aspect of the invention, the amount of the supplied cathode gas is measured on the basis of the characteristic value, which has a preliminarily known correlation with the actual amount of the supplied cathode gas, and the measurement error in the gas delivery amount sensor is calculated with reference to a measured value of the amount of the supplied cathode gas. Then in a control processing of controlling the amount of the supplied cathode gas on the basis of the value measured by the gas delivery amount sensor, the amount of the delivered cathode gas is adjusted such that the measurement error is compensated for. Accordingly, the amount of the cathode gas supplied to the fuel cell can be appropriately controlled.

In the fuel cell system according to the first aspect of the invention, the anode gas supply portion may be equipped with a pump that delivers the anode gas to the fuel cell, and the characteristic value detection portion may detect, as the characteristic value, a power consumed by the pump, which decreases as the amount of the cathode gas actually supplied to the fuel cell increases. According to this configuration, the amount of the supplied cathode gas can be measured on the basis of the power consumed by the pump that delivers the anode gas, and the measurement error in the gas delivery amount sensor with reference to the measured value of the amount of the supplied cathode gas can be calculated. Accordingly, the amount of the cathode gas supplied to the fuel cell can be appropriately controlled.

In the fuel cell system according to the first aspect of the invention, the characteristic value detection portion may detect, as the characteristic value, a pressure loss in a gas flow channel on an anode side of the fuel cell, which decreases as the amount of the cathode gas actually supplied to the fuel gas increases. According to this configuration, the amount of the supplied cathode gas can be measured on the basis of the pressure loss in the gas flow channel on the anode side of the fuel cell, and the measurement error in the gas delivery amount measurement with reference to the measured value of the amount of the supplied cathode gas can be calculated.

In the fuel cell system according to the first aspect of the invention, the characteristic value detection portion may detect, as the characteristic value, a humidity of an anode exhaust gas, which decreases as the amount of the cathode gas actually supplied to the fuel cell increases. According this configuration, the amount of the supplied cathode gas can be measured on the basis of the humidity of the anode exhaust gas, and the measurement error in the gas delivery amount sensor with reference to the measured value of the amount of the supplied cathode gas can be calculated.

In the fuel cell system according to the first aspect of the invention, the reference operation may be performed with the amount of the anode gas supplied to the fuel cell and the amount of the cathode gas supplied to the fuel cell held equal to preset constant amounts respectively and with an output of the fuel cell held equal to a preset constant output. According to this configuration, the correlation between the amount of the supplied cathode gas during the performance of the reference operation and the characteristic value can be easily acquired. Accordingly, the amount of the supplied cathode gas can be more accurately acquired on the basis of the characteristic value detected by the characteristic value detection portion.

As a second aspect of the invention, a method of controlling a fuel cell system having a gas delivery amount sensor includes performing reference operation to operate a fuel cell on a preset condition, measuring an amount of a cathode gas delivered to the fuel cell, detecting a characteristic value selected in advance as a value associated with an anode gas and correlated with an amount of the cathode gas actually supplied to the fuel cell, acquiring, as a supply amount reference value, an amount of the supplied cathode gas for the characteristic value referring to a preliminarily prepared correlation between an amount of the cathode gas supplied during performance of the reference operation and the characteristic value, and supplying the cathode gas to the fuel cell on a basis of a value measured by the gas delivery amount sensor while compensating for an error calculated as a difference between the measured amount of the cathode gas and the acquired supply amount reference value.

As a third aspect of the invention, a method of controlling a fuel cell system includes performing reference operation to operate a fuel cell on a preset condition, measuring an amount of a cathode gas delivered to the fuel cell, detecting a characteristic value selected in advance as a value associated with an anode gas and correlated with an amount of the cathode gas actually supplied to the fuel cell, and acquiring an amount of the supplied cathode gas for the characteristic value using a preliminarily prepared correlation between an amount of the cathode gas supplied during performance of the reference operation and the characteristic value. According to this aspect of the invention, the amount of the supplied cathode gas can be measured by detecting the characteristic value. Using this measured value, the amount of the supplied cathode gas can be more easily and more appropriately controlled.

It should be noted that the invention can be realized in various forms, for example, in the forms of a fuel cell system, a control method applied to the fuel cell system, a computer program for realizing the system or the method, a recording medium on which the computer program is recorded, a vehicle mounted with the fuel cell system, and the like.

### BRIEF DESCRIPTION OF THE DRAWINGS

Features, advantages, and technical and industrial significance of this invention will be described in the following detailed description of example embodiments of the invention with reference to the accompanying drawings, in which like numerals denote like elements, and wherein:

FIG. 1 is a schematic view showing the configuration of a fuel cell system;

FIG. 2 is a schematic view showing the electric configuration of the fuel cell system;

FIGS. 3A and 3B are composed of illustrative views of the process of controlling the amount of a cathode gas supplied to the fuel cell in the fuel cell system;

FIG. 4 is an illustrative view showing the processes of a measurement error compensation operation to compensate for a measurement error in an airflow meter;

FIGS. 5A and 5B are composed of illustrative views that depict the correlation between the amount of air supplied to the fuel cell and the power consumed by a hydrogen circulation pump;

FIG. 6 is an illustrative view that depicts the process of acquiring the air supply amount reference value and the calculation of a correction value;

FIG. 7 is a schematic view showing the configuration of a fuel cell system according to the second embodiment of the invention;

FIG. 8A is a flowchart of the correction value determination process performed in the fuel cell system;

FIG. 8B is a graph used as an example reference value determination map used in step S30 of the FIG. 8A;

FIG. 9 is a schematic view showing the configuration of a fuel cell system according to the third embodiment of the invention;

FIG. 10A is a flowchart of the correction value determination process executed in the fuel cell system according to the third embodiment of the invention;

FIG. 10B is a graph of an example of a reference value acquisition map used in step S30 of the FIG. 10A;

FIG. 11 is a schematic view showing the configuration of a fuel cell system according to the fourth embodiment of the invention; and

FIGS. 12A and 12B are composed of illustrative views that depict the process of controlling an amount of a supplied cathode gas in the fourth embodiment of the invention.

### DETAILED DESCRIPTION OF EMBODIMENTS

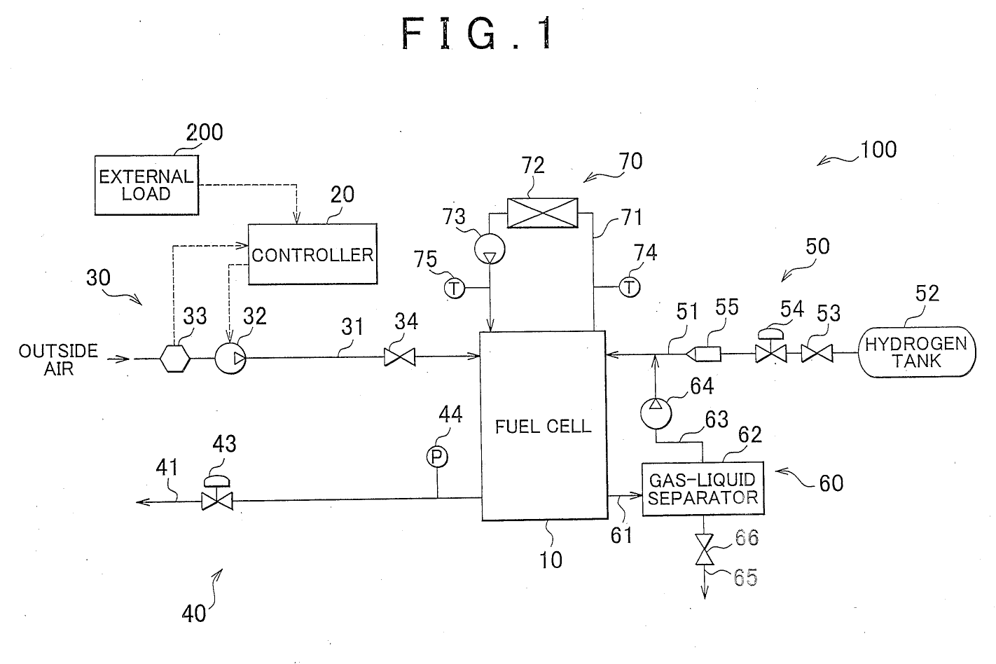

FIG. 1 is a schematic view of the configuration of a fuel cell system according to an embodiment of the invention. The fuel cell system 100 is equipped with a fuel cell 10, a controller 20, a cathode gas supply portion 30, a cathode gas discharge portion 40, an anode gas supply portion 50, an anode gas circulation discharge portion 50, and a cooling medium supply portion 70.

The fuel cell 10 is a proton-exchange membrane fuel cell that uses with hydrogen (an anode gas) and air (a cathode gas) as reactant gases to generate electricity. The fuel cell 10 has a stacked structure in which a plurality of power generators (not shown), referred to also as single cells, are laminated on one another. Each single cell has a membrane electrode assembly with electrodes integrally arranged respectively on both sides of an electrolyte membrane exhibiting good proton conductivity when moist. It should be noted that the fuel cell 10 is not limited to proton-exchange membrane fuel cells, but that other types of fuel cells may be suitably adopted as the fuel cell 10.

The controller 20 is constituted by a microcomputer equipped with a central processing unit and a main storage unit. The controller 20 receives requests for an output power from an external load 200, and controls respective constituent portions of the fuel cell system 100 in accordance with the request to cause the fuel cell 10 to generate electricity.

A cathode gas supply portion 30 includes a cathode gas pipe 31, an air compressor 32, an airflow meter 33, and an open/close valve 34. The cathode gas pipe 31 is connected to a cathode side of the fuel cell 10. The air compressor 32 is connected to the fuel cell 10 via the cathode gas pipe 31. The air compressor 32 supplies the fuel cell 10 with air compressed through the introduction of outside air as a cathode gas in response to a command from the controller 20.

The airflow meter 33 measures the amount of ambient air introduced by the air compressor 32 upstream of the air compressor 32, and sends the measured amount to the controller 20. An airflow amount measured by this airflow meter 33 represents an amount of the cathode gas delivered by the air compressor 32. The controller 20 executes a feedback control of the amount of the cathode gas supplied to the fuel cell 10 based on the measured airflow amount, but the details of this feedback control will be described later.

The open/close valve 34 is provided between the air compressor 32 and the fuel cell 10, and opens/closes in accordance with the flow of the cathode gas through the cathode gas pipe 31. More specifically, the open/close valve 34 is normally closed, and opens when air having a predetermined pressure is supplied from the air compressor 32 to the cathode gas pipe 31.

The cathode gas discharge portion 40 includes a cathode exhaust gas pipe 41, a pressure regulating valve 43, and a pressure sensor 44. The cathode exhaust gas pipe 41 is connected to the cathode side of the fuel cell 10, and discharges a cathode exhaust gas to the outside of the fuel cell system 100. The cathode exhaust gas pipe 41 is provided with the pressure regulating valve 43, and the controller 20 controls the opening degree of the pressure regulating valve 43.

The pressure sensor 44 is provided in the cathode exhaust gas pipe 41 upstream of the pressure-regulating valve 43. The pressure sensor 44 detects the pressure (back pressure) on the outlet side of the cathode of the fuel cell 10, and sends the detected pressure to the controller 20. The controller 20 adjusts the opening degree of the pressure-regulating valve 43 based on the detected pressure to control the pressure in the cathode of the fuel cell 10.

An anode gas supply portion 50 includes an anode gas pipe 51, a hydrogen tank 52, an open/close valve 53, a regulator 54, and an injector 55. The hydrogen tank 52 is connected to an anode side of the fuel cell 10 via the anode gas pipe 51, and supplies the fuel cell 10 with hydrogen from the hydrogen tank 52. Alternatively, the fuel cell system 100 may be equipped with a reformer, which generates hydrogen from a hydrocarbon fuel, as a hydrogen supply source.

The anode gas pipe 51 includes the open/close valve 53, the regulator 54, and the injector 55, which are arranged in the stated order from the hydrogen tank 52 side. The open/close valve 53 opens/closes in accordance with instructions from the controller 20, and controls the inflow of hydrogen from the hydrogen tank 52 to the upstream side of the injector 55. The regulator 54 is a pressure-reducing valve that adjusts the pressure of hydrogen upstream of the injector 55, and the opening degree of the regulator 54 is controlled by the controller 20. The injector 55 is an electromagnetically operated open/close valve in which the valve body is electromagnetically driven in accordance with a drive cycle or a valve-open time set by the controller 20. The controller 20 controls the drive cycle of the injector 55 and the valve-open time of the injector 55 to control the amount of hydrogen supplied to the fuel cell 10.

The anode gas circulation discharge portion 60 includes an anode exhaust gas pipe 61, a gas-liquid separator 62, an anode gas circulation pipe 63, a hydrogen circulation pump 64, an anode drainage pipe 65, and a drainage valve 66. The anode exhaust gas pipe 61 connects an outlet of an anode of the fuel cell 10 to the gas-liquid separator 62, and induces to the gas-liquid separator 62 an anode exhaust gas containing unreacted gases (hydrogen, nitrogen and the like).

The gas-liquid separator 62 is connected to the anode gas circulation pipe 63 and the anode drainage pipe 65. The gas-liquid separator 62 separates gas components contained in the anode exhaust gas from moisture, induces the gas components to the anode gas circulation pipe 63, and induces the moisture to the anode drainage pipe 65. The anode gas circulation pipe 63 is connected to the anode gas pipe 51 at a position downstream of the injector 55.

The hydrogen circulation pump 64 is provided in the anode gas circulation pipe 63, and causes the hydrogen contained in the gas components separated by the gas-liquid separation 62 to circulate to the anode gas pipe 51. The controller 20 then drives a drive motor (not shown) of the hydrogen circulation pump 64 at a constant preset voltage level.

The anode drainage pipe 65 drains the moisture separated by the gas-liquid separator 62 to the outside of the fuel cell system 100. The anode drainage pipe 65 includes the drainage valve 66, which opens/closes in accordance with a command from the controller 20. The controller 20 normally holds the drainage valve 66 closed during the operation of the fuel cell system 100, and opens the drainage valve 66 at predetermined intervals. Further, the controller 20 detects the concentration of hydrogen supplied in a circulatory manner to the fuel cell 10 based on the change in the amount of power generated by the fuel cell 10. If it is determined that the concentration is below a threshold concentration, the controller 20 opens the drainage valve 66 to discharge an inactive gas in the anode gas.

The cooling medium supply portion 70 is equipped with a cooling medium pipe 71, a radiator 72, a cooling medium circulation pump 73, and two cooling medium temperature sensors 74 and 75. The cooling medium pipe 71 couples an inlet manifold for a cooling medium and an outlet manifold for the cooling medium through which the cooling medium is circulated. The cooling medium is circulated to cool the fuel cell 10. The cooling medium pipe 71 is provided with the radiator 72, which exchanges heat between the cooling medium flowing through the cooling medium pipe 71 and outside air to cool the cooling medium.

The cooling medium pipe 71 is provided with the cooling medium circulation pump 73 at a position downstream of the radiator 72 (on the cooling medium inlet side of the fuel cell 10). The cooling medium circulation pump 73 delivers the cooling medium cooled by the radiator 72 to the fuel cell 10. The cooling medium pipe 71 is provided with the two cooling medium temperature sensors 74 and 75 respectively in near the cooling medium outlet of the fuel cell 10 and near the cooling medium inlet of the fuel cell 10. The cooling medium temperature sensors 74 and 75 send the detected temperatures to the controller 20. The controller 20 determines operation temperature of the fuel cell 10 based on the difference between the values measured by the two cooling medium temperature sensors 74 and 75, and controls the amount of the cooling medium delivered by the cooling medium circulation pump 73 in accordance with the detected temperatures, thereby adjusting the operation temperature of the fuel cell 10.

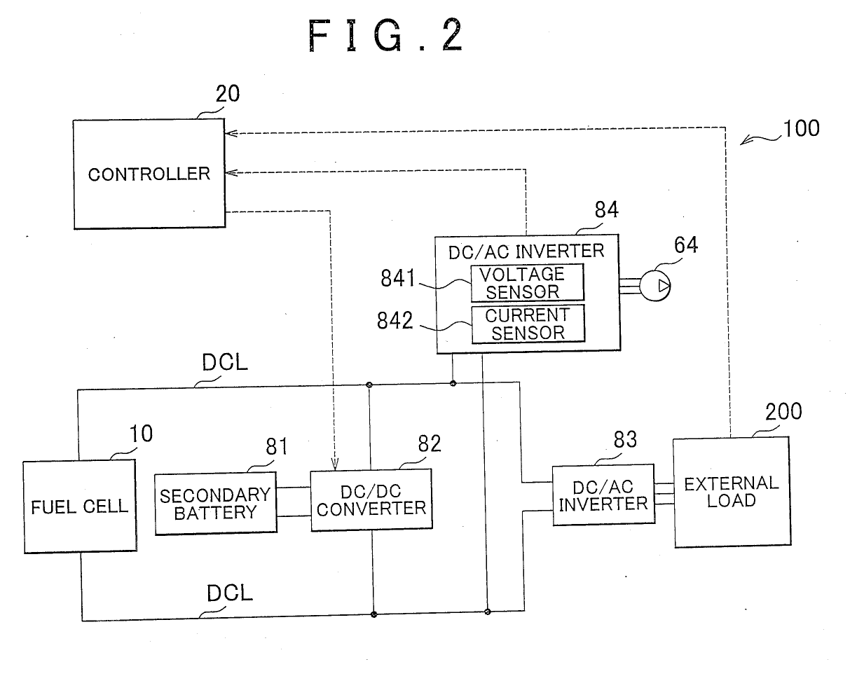

FIG. 2 is a schematic view of the electric configuration of the fuel cell system 100. It should be noted that the power output by the fuel cell 10 and the secondary battery 81 is supplied not only to the external load 200 and the hydrogen circulation pump 64 but also to other auxiliaries of the fuel cell system 100 in the fuel cell system 100. However, the pipes for supplying the power to the auxiliaries are not illustrated or described.

The fuel cell system 100 is equipped with a secondary battery 81, a DC/DC converter 82, a first DC/AC inverter 83, and a second DC/AC inverter 84. The first DC/AC inverter 83 is connected to the external load 200, and the second DC/AC inverter 84 is connected to a drive motor (not shown) of the hydrogen circulation pump 64. The first DC/AC inverter 83 and the second DC/AC inverter 84 are connected to the fuel cell 10 in parallel with each other, via a direct-current power supply line DCL.

The first DC/AC inverter 83 and the second DC/AC inverter 84 convert direct-current power output by the fuel cell 10 and the secondary battery 81 into alternating-current power, and supply the alternating-current power to the external load 200 and the hydrogen circulation pump 64 respectively. It should be noted that the second DC/AC inverter 84 includes a voltage sensor 841 and a current sensor 842. The controller 20 measures the power consumed by the hydrogen circulation pump 64 based on the readings of the voltage sensor 841 and the current sensor 842.

The secondary battery 81 is connected to the direct-current power supply line DCL via the DC/DC converter 82. The secondary battery 81 functions as an auxiliary power supply for the fuel cell 10, and can be constituted by, for example, a rechargeable lithium-ion battery. The DC/DC converter 82 has a function as a charge/discharge controller that controls the charge/discharge of the secondary battery 81, and variably adjusts the voltage level of the direct-current power supply line DCL in accordance with the instructions from the controller 20.

When the output of the fuel cell 10 is insufficient for an output request from the external load 200, the controller 20 instructs the DC/DC converter 82 to discharge power from the secondary battery 81, thereby compensating for the deficiency in output. It should be noted that when the external load 200 generates a regenerative power, the regenerative power is converted into a direct-current power by the first DC/AC inverter 83 and used to charge the secondary battery 81 via the DC/DC converter 82.

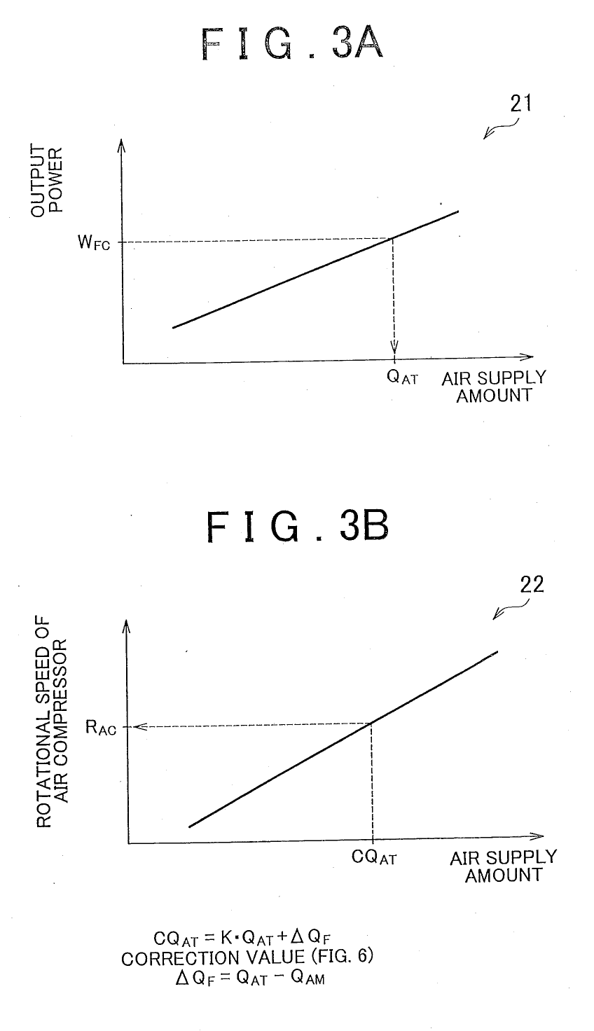

FIGS. 3A and 3B illustrate the process of controlling the amount of the cathode gas supplied to the fuel cell 10 in the fuel cell system 100. In the fuel cell system 100, the controller 20 controls the rotational speed of the air compressor 32 using two maps 21 and 22 stored in a storage portion. The maps 21 and 22 are used in controlling the amount of the cathode gas supplied to the fuel cell 10 (hereinafter referred to also as “the amount of supplied air”).

In FIG. 3A, an example of the air supply amount determination map 21 used to determine the amount of supplied air, namely, the amount of the air supplied to the fuel cell 10 (a target air supply amount) is expressed by a graph in which the ordinate represents the output voltage of the fuel cell 10 and the abscissa represents the amount of supplied air. In the air supply amount determination map 21, the amount of supplied air linearly increases with increases in the output voltage of the fuel cell 10. The controller 20 sets a target output power W_{FC} to be output by the fuel cell 10 based on the amount of power requested by the external load 200. Using the air supply amount determination map 21, the controller 20 then determines the target air supply amount Q_{AT} for the target output power W_{FC} (indicated by a broken arrow in the graph).

In FIG. 3B, an example of the rotational speed determination map 22 for determining the rotational speed of the air compressor 32 is expressed by a graph in which the ordinate represents the rotational speed of the air compressor 32 and the abscissa represents the amount of supplied air. In this rotational speed determination map 22, the rotational speed of the air compressor 32 linearly increases with increases in the amount of supplied air.

The controller 20 determines the post-correction target air supply amount CQ_{AT}, which is obtained by multiplying the target air supply amount Q_{AT} by a correction value K and adding a feedback correction value ΔQ_{F} thereto (i.e., CQ_{AT}=K·Q_{AT}+ΔQ_{F}). It should be noted herein that “the correction value K” compensates for measurement errors of the airflow meter 33, and is determined through a later-described correction value determination process. Further, the feedback correction value ΔQ_{F} is the amount of supplied air for performing feedback control of the amount of supplied air based on the amount of air measured by the airflow meter 33. The controller 20 calculates the feedback correction value ΔQ_{F}, which is the difference between the target air supply amount Q_{AT} and the air supply amount Q_{AM} measured by the airflow meter 33 (ΔQ_{F}=Q_{AT}−Q_{AM}).

Using the rotational speed determination map 22, the controller 20 determines the rotational speed R_{AC} of the air compressor for the post-correction target air supply amount CQ_{AT} (hereinafter referred to as “a command rotational speed R_{AC}”). The controller 20 then drives the air compressor 32 at the command rotational speed R_{AC} to supply the fuel cell 10 with the appropriate amount of cathode gas. Thus, in the fuel cell system 100 according to this embodiment of the invention, the amount of supplied air is subjected to feedback control based on the readings from the airflow meter 33 to enable the appropriate control of the amount of supplied air.

A measurement error in the airflow meter 33 may occur due to an initial defect of the airflow meter 33, the deterioration of the airflow meter 33, or the like. When there is produced a positive-side measurement error in the airflow meter 33, the amount of supplied air is reduced below the target value, so that it may be impossible to produce the target output in the fuel cell 10. Further, when the amount of supplied air is thus controlled to a small value, insufficient moisture is drained from the fuel cell 10, so that the deterioration in the power generation performance of the fuel cell 10 may occur.

In contrast, when there is produced a negative-side measurement error in the airflow meter 33, the amount of supplied air exceeds the target value. If the amount of air supplied to the fuel cell 10 is equal to or exceeds the target value, the amount of drainage from the fuel cell 10 increases, the electrolyte membrane dries, and the output of the fuel cell 10 may decrease. Thus, in the fuel cell system 100, the measurement error in the airflow meter 33 is calculated based on the power consumed by the hydrogen circulation pump 64, and the correction value K used to compensate for the measurement error is determined.

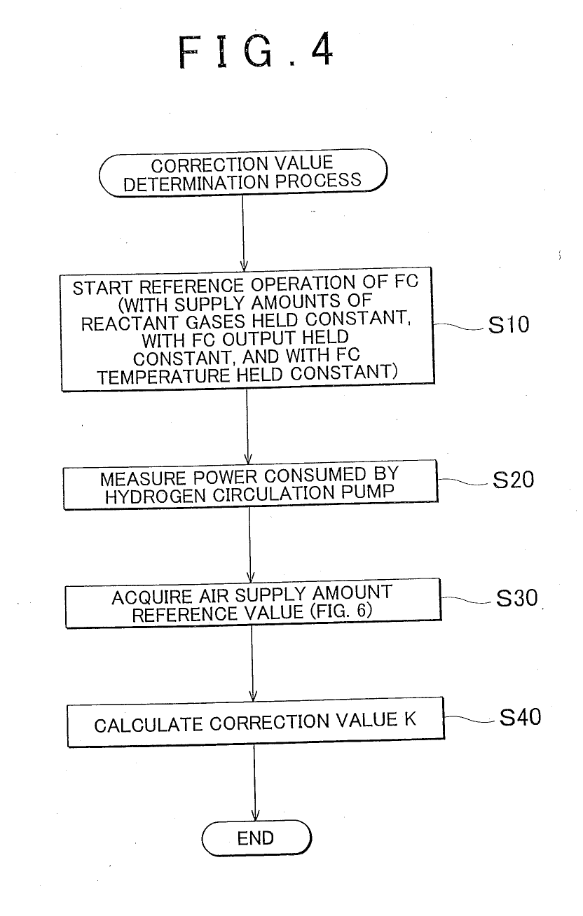

FIG. 4 is a flowchart showing the steps of a correction value determination process used to determine the correction value for the measurement error in the airflow meter 33. The controller 20 regularly executes the measurement error compensation process when the operation of the fuel cell system 100 is terminated. That is, the measurement error in the airflow meter 33 is corrected in the operation following the restart of the fuel cell system 100.

In step S10, the controller 20 starts reference operation to operate the fuel cell 10 on a preset condition. More specifically, the controller 20 executes the control to start the supply of reactant gases such that preset constant amounts of the reactant gases are supplied to the fuel cell 10. That is, as for the control of supplying the cathode gas the air compressor 32 is driven with a preset amount of supplied air set as a target amount of supplied air, and the pressure regulating valve 43 is opened to a predetermined opening degree. In contrast, as for the control of supplying the anode gas, the injector 55 is driven on a preset drive cycle and the hydrogen circulation pump 64 is driven at a predetermined voltage.

Further, the controller 20 instructs the DC/DC converter 82 to control the fuel cell 10 to output a constant power. The controller 20 also controls the rotational speed of the cooling medium circulation pump 73 to stabilize the operation state of the fuel cell 10, thereby, maintaining the fuel cell temperature at a prescribed operating temperature (e.g., 80° C.). It should be noted that the output power of the fuel cell 10 generated in the reference operation may be stored in the secondary battery 81.

In step S20, the controller 20 measures the power consumed by the hydrogen circulation pump 64 when the fuel cell 10 performs the reference operation. More specifically, the controller 20 may calculate the time average of the power consumed by the hydrogen circulation pump 64 in a certain period during which reference operation is performed. It should be noted that the inventors of the invention have found out that there is a later-described correlation between the power consumed by the hydrogen circulation pump 64 and the amount of supplied air.

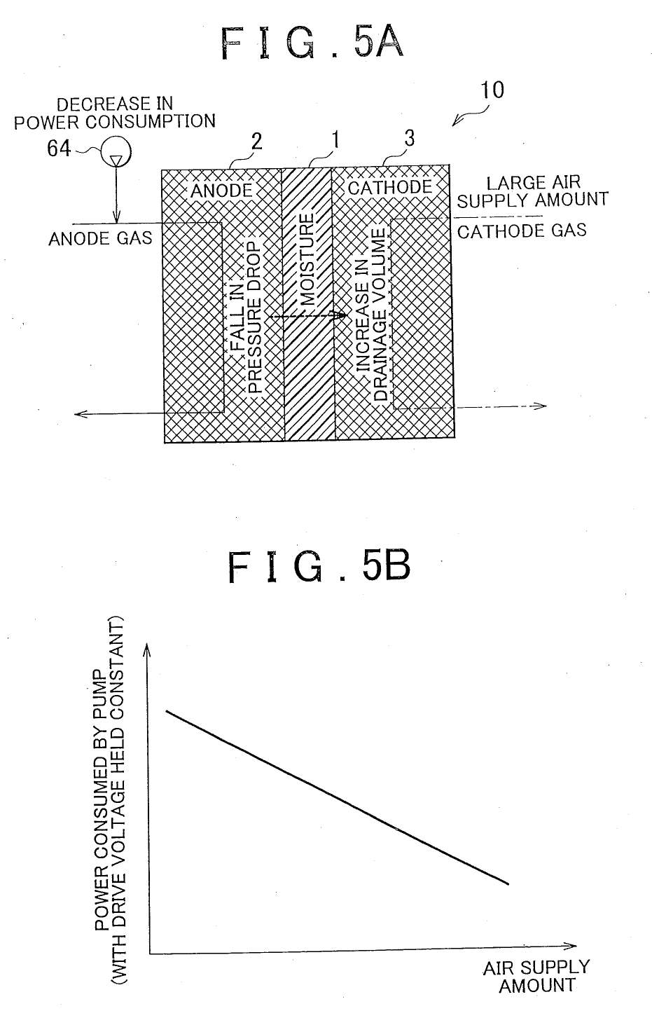

FIGS. 5A and 5B are illustrative views for illustrate the correlation between the amount of the air supplied to the fuel cell and the power consumed by the hydrogen circulation pump 64. FIG. 5A is a schematic view of the correlation between the amount of supplied air and the pressure loss in a gas flow channel on an anode side of the fuel cell 10. In FIG. 5A, the fuel cell 10 and the hydrogen circulation pump 64 are schematically illustrated, and the arrows illustrate the flow of the reactant gases and the movement of moisture.

The fuel cell 10 has an electrolyte membrane 1, and an anode 2 and a cathode 3 that are arranged on opposite sides of the electrolyte membrane 1. The anode 2 and the cathode 3 are constituted by porous electrically conductive members that are gas permeable. The porous electrically conductive members also function as gas flow channels through which the reactant gases are diffused to spread all over electrodes.

It is assumed herein that the amount of the air supplied to the cathode 3 is gradually increased during the operation of the fuel cell 10. In this case, as the amount of supplied air increases, the amount of the cathode exhaust gas increases, and the amount of the moisture drained from the cathode 3 also increases. The movement of the moisture from the anode 2 to the cathode 3 via the electrolyte membrane 1 is then promoted. That is, as the amount of supplied air increases, the amount of moisture contained in fine pores of the anode 2 decreases, and the pressure loss in the anode 2 decreases. When the pressure loss in the anode 2 decreases, the load torque for the hydrogen circulation pump 64 also decreases. Therefore, the power consumed by the hydrogen circulation pump 64 decreases as well.

FIG. 5B is a graph that shows the correlation between the amount of supplied air and the power consumed by the hydrogen circulation pump 64 when the fuel cell 10 performs the reference operation. As in the case where the fuel cell 10 performs the reference operation, it is assumed that the hydrogen circulation pump 64 is driven at a constant voltage so that the fuel cell 10 outputs a constant power. In this case, as the amount of the air supplied to the fuel cell 10 increases, the pressure loss in the anode 2 linearly decreases, and the power consumed by the hydrogen circulation pump 64 also linearly decreases.

By determining the correlation between the amount of supplied air and the power consumed by the hydrogen circulation pump 64 in advance, the amount of the air supplied to the fuel cell 10 may be measured based on the measured amount of power consumed by the hydrogen circulation pump 64. Thus, in the following process, the fuel cell system 100 determines the amount of supplied air for the measured amount of power consumed by the hydrogen circulation pump 64, and calculates the measurement error in the airflow meter 33 in accordance with the amount of the supplied air.

It should be noted that the amount of supplied air measured by the airflow meter 33 will be referred to hereinafter as the “measured amount of supplied air”. Further, the amount of supplied air acquired on the basis of the power consumed by the hydrogen circulation pump 64 will be referred to as “a reference amount of supplied air”.

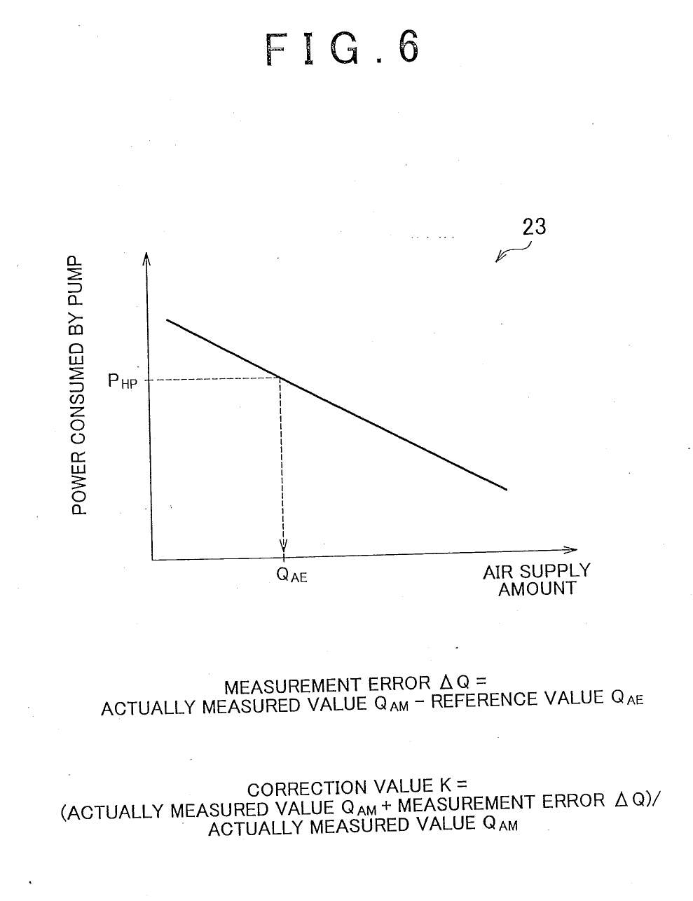

FIG. 6 is illustrates the process of determining the reference amount of supplied air in step S30 and the process of calculating the correction value K in step S40. In FIG. 6, an example of a reference value determination map 23 used to determine the reference amount of supplied air is shown as a graph in which the ordinate represents the measured amount of power consumed by the hydrogen circulation pump 64 and the abscissa represents the amount of supplied air. A correlation between the power consumed by the hydrogen circulation pump 64 and the amount of supplied air, as described with reference to FIG. 5B, is set in the reference value determination map 23. Using the reference value determination map 23, the controller 20 determines the reference value Q_{AE} of the amount of supplied air for given measured value P_{HP} of the power consumed by the hydrogen circulation pump 64 acquired in step S20 (indicated by the broken arrow in the graph).

In step S40, a difference ΔQ between the reference value Q_{AE} of the amount of supplied air determined in step S30 and the measured value of the airflow meter 33 is calculated as a measurement error in the airflow meter 33 (Expression (1)).

ΔQ=Q_{AM}−Q_{AE} (1)

The correction value K for compensating for the measurement error is calculated according to the following expression (2).

K=(Q_{AM}+ΔQ)/Q_{AM} (2)

The controller 20 stores the correction value K into the storage portion (not shown) in a nonvolatile manner. The controller 20 then reads out the correction value K after the fuel cell system 100 is restarted, and uses the correction value K to control the driving of the air compressor 32 (FIG. 3B).

As described above, in the fuel cell system 100 the power consumed by the hydrogen circulation pump 64 is detected as a value associated with the anode gas and correlated with the actual amount of supplied air in the correction value determination process. A measurement error in the airflow meter 33 is then calculated with reference to the amount of supplied air acquired for the detected amount of power consumed, by the hydrogen circulation pump 64, and a correction value for compensating for the measurement error is determined. By executing the feedback control based on the measured value of the airflow meter 33 using this correction value, the measurement error in the airflow meter 33 is compensated for. Therefore, the appropriate control of supplying the cathode gas is possible.

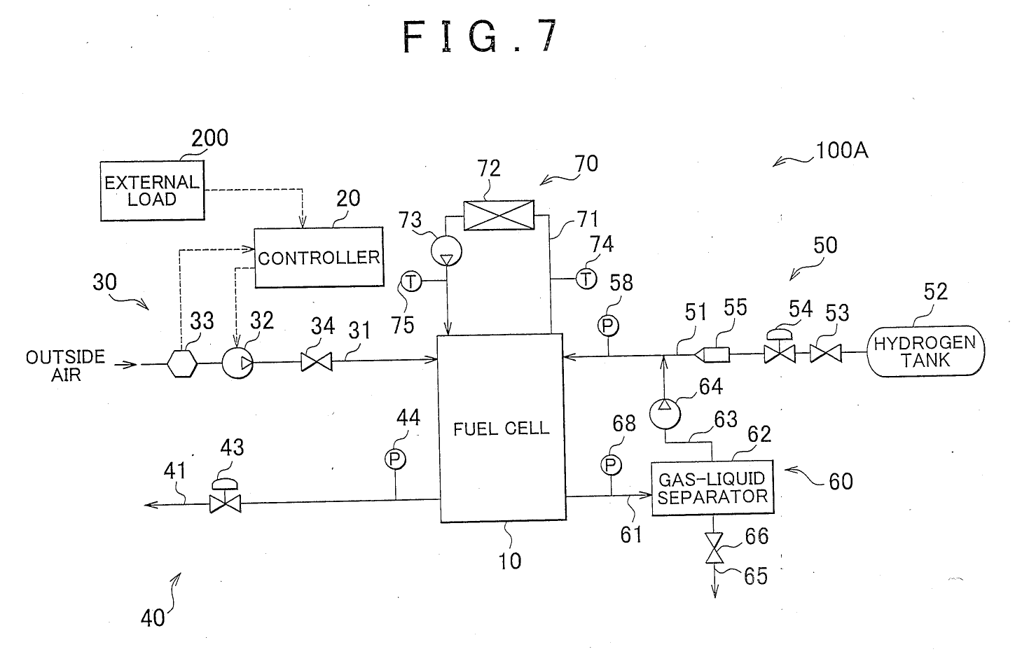

FIG. 7 is a schematic view of the configuration of a fuel cell system 100A according to the second embodiment of the invention. FIG. 7 is substantially identical to FIG. 1 except in that a first hydrogen pressure sensor 58 and a second hydrogen sensor 68 are provided. The anode gas pipe 51 is provided with the first hydrogen pressure sensor 58 at a position downstream of a junction portion with the anode gas circulation pipe 63. The first hydrogen pressure sensor 58 measures the pressure of supplied hydrogen near an anode inlet of the fuel cell 10. The anode exhaust gas pipe 61 is provided with the second hydrogen pressure sensor 68, which measures the pressure of exhaust gas near an anode outlet of the fuel cell 10.

It should be noted that the fuel cell system 100A is identical in electric configuration to the fuel cell system 100 of the first embodiment (FIG. 2). Further, the control of supplying the cathode gas in the fuel cell system 100A employs the same feedback control based on the value measured by the airflow meter 33 as in the fuel cell system 100 (FIG. 3).

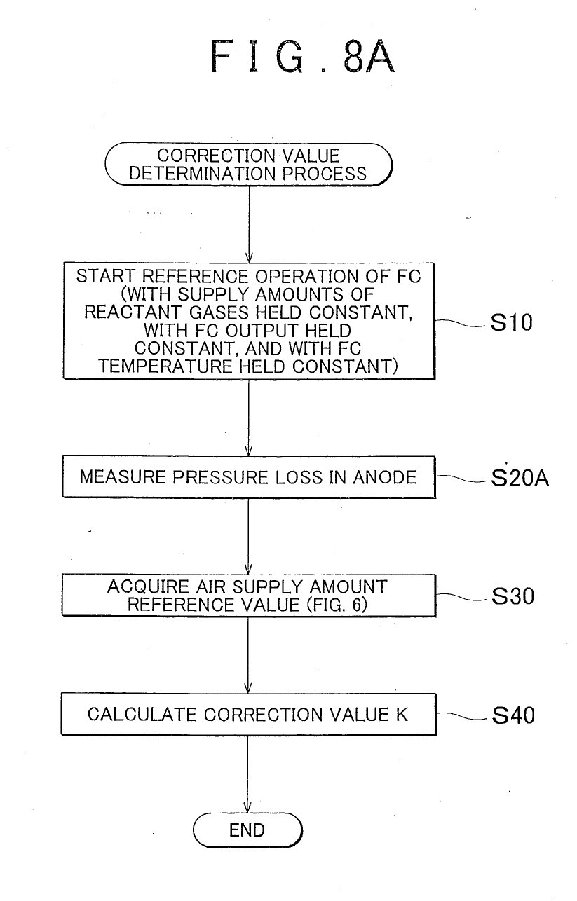

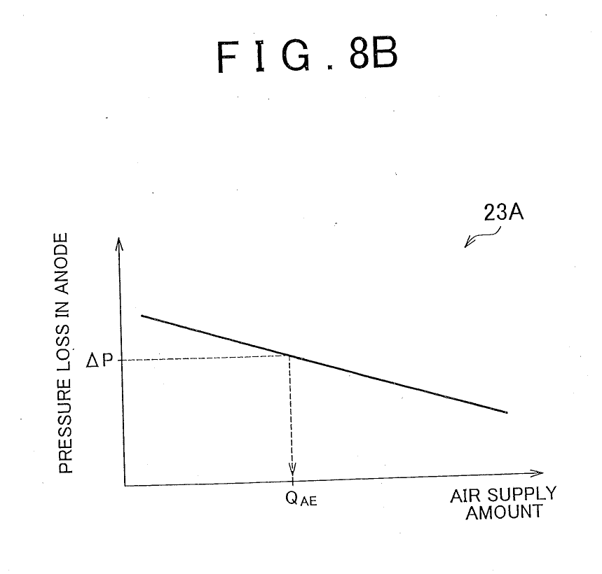

FIG. 8A is a flowchart of the correction value determination process performed in the fuel cell system 100A. FIG. 8A is substantially identical to FIG. 4 except in that a process of step S20A is provided instead of a process of step S20. In step S20A, the controller 20 acquires the pressure measured by the first hydrogen pressure sensor 58 and the pressure measured by the second hydrogen pressure sensor 68. The controller 20 determines the pressure loss in the anode of the fuel cell 10 based on the difference between these measured pressures.

FIG. 8B is a graph used as an example reference value determination map 23A used in step S30. In FIG. 8B, the reference value determination map 23A is illustrated as a graph in which the ordinate represents the pressure loss in the anode of the fuel cell 10 and the abscissa represents the amount of supplied air. It should be noted herein that, as described with reference to FIG. 5A, the pressure loss in the anode of the fuel cell 10 linearly decreases with increases in the amount of supplied air when the reference operation of the fuel cell 10 is performed.

In the reference value determination map 23A according to the second embodiment of the invention, a proportional relationship between the amount of supplied air and the pressure loss in the anode of the fuel cell 10 during the performance of the reference operation is set. Using the reference value determination map 23A, the controller 20 acquires, as the reference value Q_{AE} of the amount of supplied air, the amount of supplied air for the pressure loss ΔP in the anode of the fuel cell 10 acquired in step 20 (step S30). Then in step S40, the controller 20 calculates the correction value K using expressions (1) and (2), as described in the first embodiment of the invention.

As described above, in the fuel cell system 100A according to the second embodiment of the invention, the pressure loss in the gas flow channel on the anode side of the fuel cell 10 is measured as a value associated with the anode gas and correlated with the actual amount of supplied air. The correction value determination process is then executed using the measured value. Accordingly, the measurement error in the airflow meter 33 can be appropriately compensated for in the control of supplying the cathode gas.

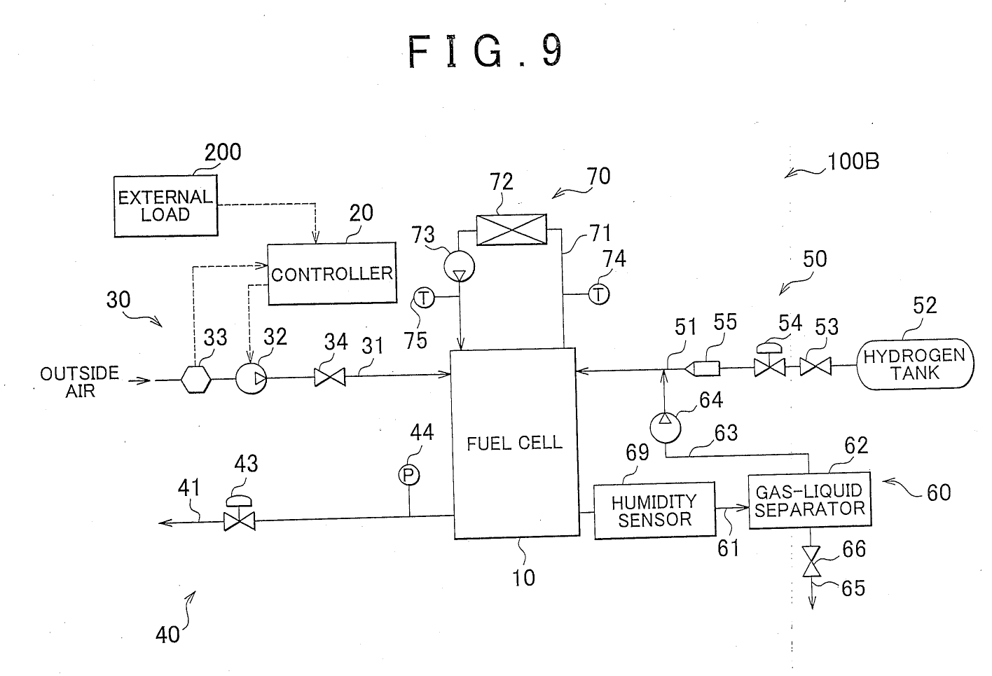

FIG. 9 is a schematic view of the configuration of a fuel cell system 100B according to the third embodiment of the invention. FIG. 9 is substantially identical to FIG. 7 except in that a humidity sensor 69 is provided instead of the first hydrogen pressure sensor 58 and the second hydrogen pressure sensor 68. The anode exhaust gas pipe 61 is provided with the humidity sensor 69, which measures a humidity of the anode exhaust gas and sends the measured humidity to the controller 20.

It should be noted that the fuel cell system 100B according to the third embodiment of the invention is identical in electric configuration to the fuel cell system 100A according to the second embodiment of the invention (FIG. 2). Further, as for the control of supplying the cathode gas in the fuel cell system 100B, the same feedback control based on the value measured by the airflow meter 33 as in the fuel cell system 100A is performed (FIG. 3).

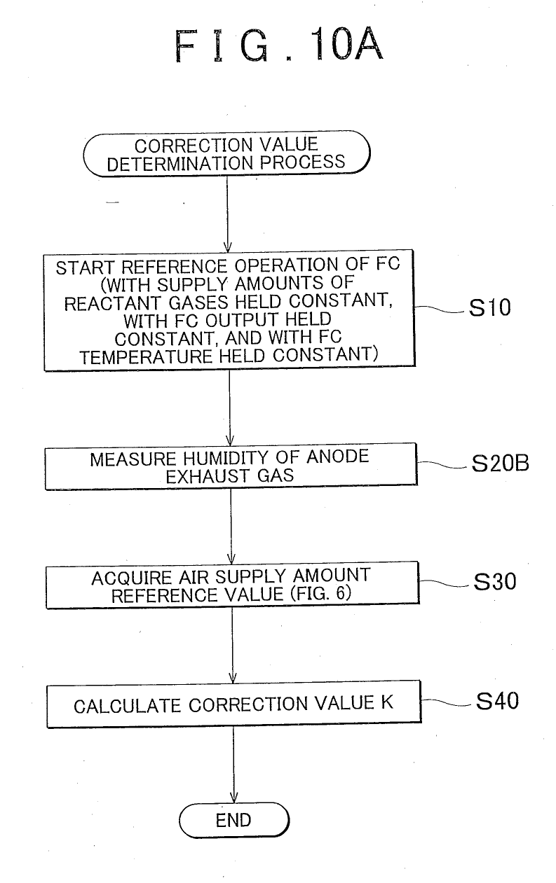

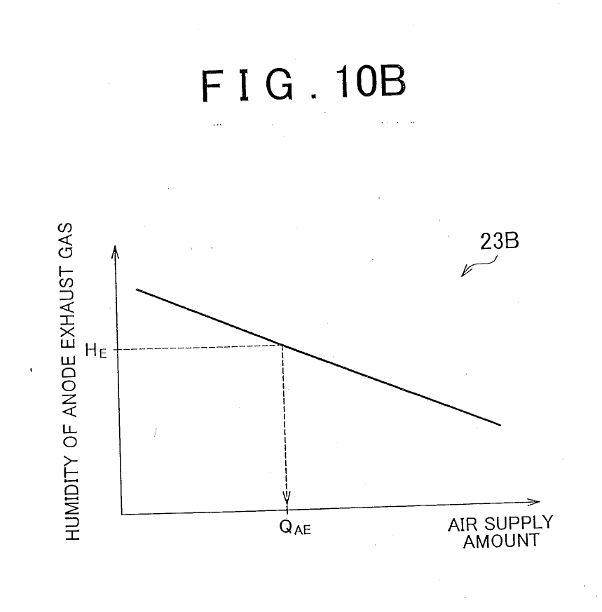

FIG. 10A is a flowchart of the correction value determination process executed in the fuel cell system 100B according to the third embodiment of the invention. FIG. 10A is substantially identical to FIG. 8A except that a process of step S20B is provided instead of a process of step S20A. In step S20B, the controller 20 acquires a humidity measured by the humidity sensor 69.

FIG. 10B is a graph of an example of a reference value acquisition map 23B used in step S30. In FIG. 10B, the reference value determination map 23B is illustrated as a graph in which the ordinate represents the humidity of the anode exhaust gas and the abscissa represents the amount of supplied air. It should be noted that the moisture in the anode 2 of the fuel cell 10 moves toward the cathode 3 side via the electrolyte membrane 1 as the amount of the air supplied to the fuel cell 10 increases, as described with reference to FIG. 5A. In particular, when the reference operation of the fuel cell 10 is performed, the amount of moisture moving toward the cathode 3 side linearly increases with increases in the amount of supplied air. Therefore, the humidity of the anode exhaust gas linearly decreases.

In the reference value determination map 23B according to the third embodiment of the invention, the amount of supplied air is proportional to the humidity of the anode exhaust gas during the performance of the reference operation. Using the reference value determination map 23B, the controller 20 determines, as the reference value Q_{AE} of the amount of supplied air, the amount of supplied air for a humidity H_{E} of the anode exhaust gas of the fuel cell 10 acquired in step 20 (step S30). Then in step S40, the controller 20 calculates the correction value K using the expressions (1) and (2) described in the first embodiment of the invention.

As described above, in the fuel cell system 100B according to the third embodiment of the invention, the humidity of the anode exhaust gas is detected as a value associated with the anode gas and correlated with the actual amount of supplied air. The measurement error in the airflow meter 33 is then calculated using the reference amount of supplied air determined from the detected humidity and the measured value of the amount of supplied air, and the amount of the supplied cathode gas is controlled to compensate for the measurement error. Accordingly, the amount of the supplied cathode gas is more appropriately controlled.

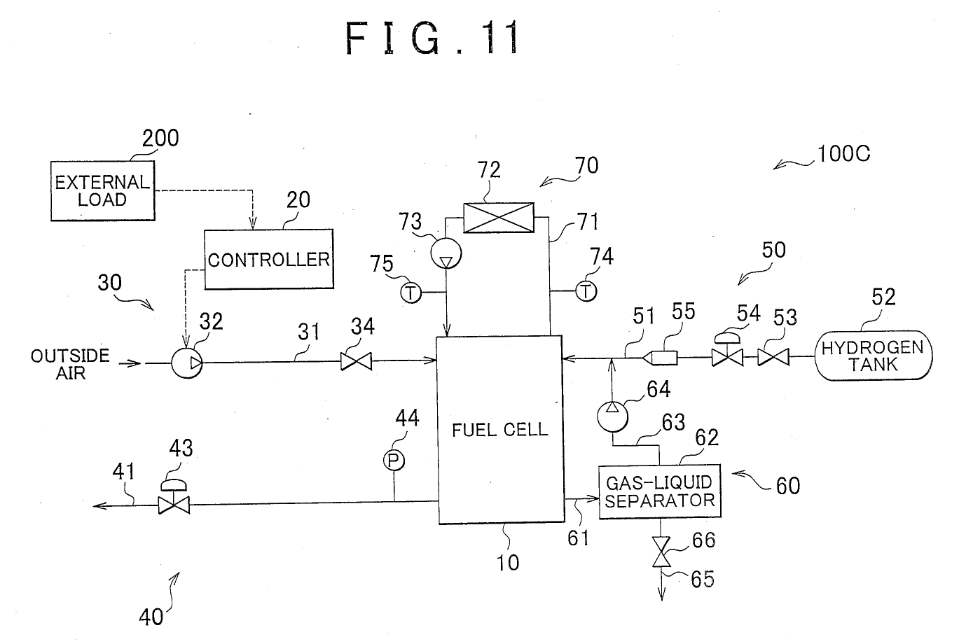

FIG. 11 is a schematic view of the configuration of a fuel cell system 100C according to the fourth embodiment of the invention. FIG. 11 is substantially identical to FIG. 1 except in that the airflow meter 33 is omitted. It should be noted that the electric configuration of the fuel cell system 100C is substantially identical to the configuration described in the first embodiment of the invention (FIG. 2).

In this fuel cell system 100C, the fuel cell 10 is controlled to generate electricity under the same condition as the reference operation described in the first embodiment of the invention in normal operation to output the requested power for an external load 200. That is, the controller 20 supplies the fuel cell 10 with a constant target supply amount of the reactant gases, and controls the fuel cell 10 to output a constant level of power. It should be noted the secondary battery 81 compensates for any shortfalls in power from the fuel cell 10 for the external load 200.

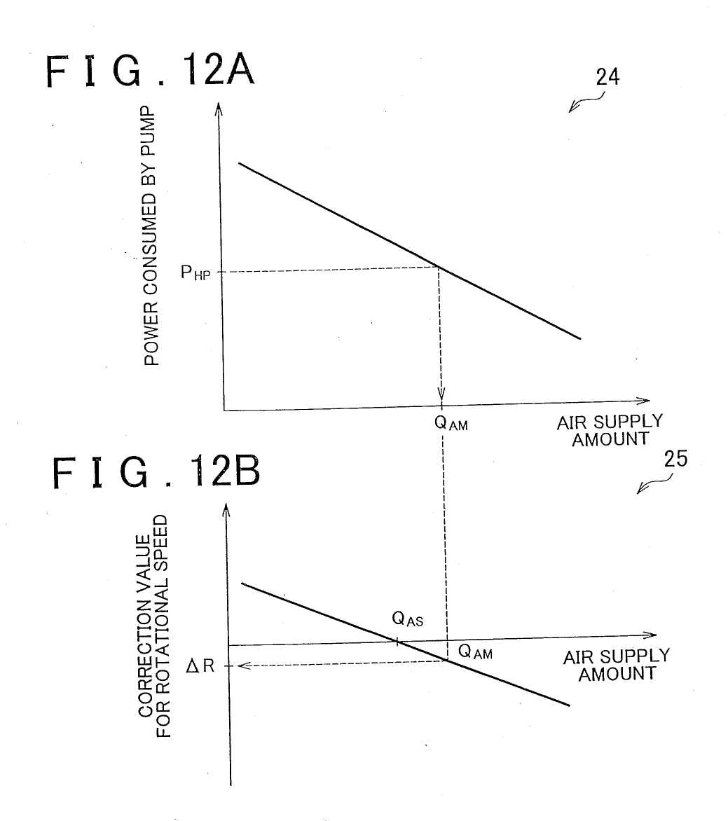

FIGS. 12A and 12B illustrate the process of controlling the amount of the supplied cathode gas in the fuel cell system 100C. FIG. 12A is an air supply amount measurement map 24 used to determine the actually measured amount of supplied air based on the power consumed by the hydrogen circulation pump 64. The air supply amount measurement map 24 is a map similar to the air supply amount reference value determination map 23 (FIG. 6) described in the first embodiment of the invention.

The controller 20 measures the power consumed by the hydrogen circulation pump 64, and acquires the actually measured value Q_{AM} of the amount of supplied air, the amount of supplied air for the measured value P_{HP} using the air supply amount measurement map 24. The controller 20 corrects the rotational speed of the air compressor 32 based on measured value Q_{AM} of the amount of supplied air, thereby performing the feedback control of the amount of supplied air.

In FIG. 12B, an example of a rotational speed correction value determination map 25 used by the controller 20 to determine the correction value for the rotational speed of the air compressor 32 is expressed by a graph in which the ordinate represents the correction value and the abscissa represents the amount of supplied air. In the graph of FIG. 12B, the abscissa corresponds to that of the graph of FIG. 12A.

This rotational speed correction value determination map 25 is set based on the correlation between the correction value and the amount of supplied air, which may be obtained in advance experimentally. In the fourth embodiment of the invention, in the rotational speed correction value determination map 25, the correction value of the rotational speed of the air compressor 32 linearly decreases with increases in the amount of supplied air. It should be noted that an initial set value, Q_{AS} is set as a target value of the amount of supplied air to have the fuel cell 10 to output a certain power. In the rotational speed correction value determination map 25, a negative-side correction value is obtained if the measured amount of supplied air exceeds the initial set value Q_{AS}, and a positive-side correction value is obtained if the measured value of the amount of supplied air is below the initial set value Q_{AS}.

Using the rotational speed correction value determination map 25, the controller 20 determines the correction value ΔR for the rotational speed of the air compressor 32 for a given measured value Q_{AM} of the amount of supplied air. The controller 20 adjusts the rotational speed of the air compressor 32 based on the correction value ΔR. As described above, in the fuel cell system 100C according to the fourth embodiment, the feedback control of the amount of supplied air is executed by measuring the amount of supplied air based on the measured amount of power consumed by the hydrogen circulation pump 64 and the air supply amount measurement map 24. That is, even if the airflow meter 33 is dispensed with, the amount of the supplied cathode gas may be appropriately controlled based on the power consumed by the hydrogen circulation pump 64.

It should be noted that this invention is not limited to the above embodiments, but can be implemented in various modes without departing from the scope thereof. For example, the invention may be modified as described below.

In each of the above embodiments of the invention, the reference value of the amount of supplied air is determined using the power consumed by the hydrogen circulation pump 64, the pressure loss in the gas flow channel on the anode side of the fuel cell 10, or the humidity of the anode exhaust gas, which are used as the value associated with the anode gas and correlated with the actual amount of supplied air. However, in the first modified example, another value may be detected as the value associated with the anode gas and correlated with the actual amount of supplied air.

In each of the above embodiments of the invention, the controller 20 acquires the target amount of supplied air, the reference value of the amount of supplied air, or the correction value for the rotational speed of the air compressor 32, which controls the amount of the supplied cathode gas, using one of the maps 21 to 25 as the corresponding relationship (the correlation) stored in advance. However, in the second modified example, instead of the maps 21 to 25, a formula, a function or the like that represents the correlation similar to those shown in the maps 21 to 25 may be stored in the controller 20.

In each of the first to third embodiments of the invention, the correction value determination process is executed when the operation of the fuel cell system 100, 100A, or 100B is terminated. However, in the third modified example, the correction value determination process may be executed at another timing. For example, the correction value determination process may be executed upon receiving instructions from a user or when the system is started. It should be noted that it is more preferable to execute the correction value determination process when the operation of the fuel cell system 100, 100A, or 100B is terminated, because conditions such as, for example, the temperature of the fuel cell 10 is likely to be relatively stable.

In each of the first to third embodiments of the invention, a control to maintain the amounts of the supplied reactant gases, the output of the fuel cell 10, or the temperature of the fuel cell 10 at a constant level is executed as the reference operation of the fuel cell 10 in the correction value determination process. However, in the fourth modified example, the reference operation of the fuel cell 10 may be the operation on another preset condition. For example, the amounts of the supplied reactant gases may change with time as set in advance. It should be noted that a reference value determination map is desired to be prepared in accordance with the condition of the reference operation in this case.

None of the above embodiments include a humidifier for humidifying the cathode gas in the cathode gas supply portion 30. However, according to the fifth modified example, such a humidifier may be provided in the cathode gas supply portion 30 to maintain sufficient moisture in the electrolyte membrane during the operation of the fuel cell 10. However, when the humidification portion is provided, the measurement error in the airflow meter 33 may be rounded off the humidification portion. Thus, the control of supplying the cathode gas described in each of the above embodiments of the invention is better suited for fuel cell systems in which a humidifier is not provided in the cathode gas supply portion 30.

In each of the described embodiments of the invention, the controller 20 determines the correction value K or the correction value ΔR for the rotational speed of the air compressor 32 to appropriately compensate for the measurement error in the airflow meter 33. However, as the sixth modified example, the controller 20 may compensate for the measurement error in the airflow meter 33 through another method in the control of the amount of the supplied cathode gas. For example, the controller 20 may correct the rotational speed determination map 22 for the air compressor 32 to appropriately compensate for the measurement error in the airflow meter 33. More specifically, the controller 20 may multiply the rate of change in the rotational speed of the air compressor 32 with respect to the amount of supplied air in the rotational speed determination map 22 by the ratio (Q_{AM}/Q_{AE}) of the reference value Q_{AE} of the amount of supplied air to the actually measured value Q_{AM} of the amount of supplied air.

In the first embodiment of the invention, the fuel cell system 100 includes the injector 55 for supplying the anode gas to the fuel cell 10, and the hydrogen circulation pump 64 for circulating the anode exhaust gas to the fuel cell 10. However, as in the seventh modified example, the fuel cell system 100 may instead be equipped with a pump for supplying hydrogen to the fuel cell 10 instead of the injector 55 and the hydrogen circulation pump 64. In this case, in the correction value determination process, the air supply amount reference value may be determined based on the power consumed by the pump.

In the first embodiment of the invention, the controller 20 drives the hydrogen circulation pump 64 at a constant voltage. However, in the eighth modified example, the controller 20 may instead drive the hydrogen circulation pump 64 at a constant rotational speed or the amount of the gas delivered by the hydrogen circulation pump 64 constant. In this case, the controller 20 detects the rotational speed of the hydrogen circulation pump controller 64 or the amount of the gas delivered by the hydrogen circulation pump 64 to perform feedback control.

In the fourth embodiment of the invention, the controller 20 controls the fuel cell 10 to output a constant amount of power. However, in the ninth modified example, the controller 20 may control the fuel cell 10 to output power at preset multistage output levels. Accordingly, an air supply amount measurement map 24 may be prepared for each output level.

1. A fuel cell system comprising:
a fuel cell;
a cathode gas supply portion that supplies a cathode gas to the fuel cell;
a gas delivery amount sensor that measures an amount of the cathode gas supplied to the fuel cell;
an anode gas supply portion that supplies an anode gas to the fuel cell;
a characteristic value detection portion that detects a characteristic value associated with the anode gas and correlated with an amount of the cathode gas actually supplied to the fuel cell; and
a controller that controls an amount of the anode gas and the amount of the cathode gas supplied to the fuel cell to control operation of the fuel cell,
wherein
a correlation between the characteristic value and an amount of cathode gas supplied to the fuel cell when a reference operation is performed to operate the fuel cell on a preset condition is stored in the controller,
the controller instructs the fuel cell to perform the reference operation, acquires the amount of the cathode gas supplied to the fuel cell measured by the gas delivery amount sensor, detects the characteristic value, acquires, as a supply amount reference value, the amount of the supplied cathode gas for the detected characteristic value using the correlation, and calculates, as an error in the value measured by the gas delivery amount sensor, the difference between the supply amount reference value and the value measured by the gas delivery amount sensor, and
the controller adjusts the amount of the cathode gas supplied by the cathode gas supply portion such that the error in the value measured by the gas delivery amount sensor is compensated for in supplying the cathode gas to the fuel cell, using a correction value that is calculated on the basis of the difference between the supply amount reference value and the value measured by the gas delivery amount sensor.

2. The fuel cell system according to claim 1, wherein the anode gas supply portion includes a pump that delivers the anode gas to the fuel cell,
the characteristic value is a power consumed by the pump, which decreases as the amount of the cathode gas actually supplied to the fuel cell increases.

3. The fuel cell system according to claim 1, wherein the characteristic value is a pressure loss in a gas flow channel on an anode side of the fuel cell, which decreases as the amount of the cathode gas actually supplied to the fuel cell increases.

4. The fuel cell system according to claim 1, wherein the characteristic value is a humidity of an anode exhaust gas, which decreases as the amount of the cathode gas actually supplied to the fuel cell increases.

5. The fuel cell system according to claim 1, wherein the reference operation is performed with the amount of the anode gas supplied to the fuel cell and the amount of the cathode gas supplied to the fuel cell held equal to preset constant amounts respectively and with an output of the fuel cell held equal to a preset constant output.

6. A method of controlling a fuel cell system that includes a gas delivery amount sensor, which measures an amount of a cathode gas supplied to the fuel cell, the method comprising:
performing reference operation to operate the fuel cell on a preset condition;
measuring the amount of a cathode gas supplied to the fuel cell;
detecting a characteristic value associated with an anode gas and correlated with an amount of the cathode gas actually supplied to the fuel cell;
acquiring, as a supply amount reference value, a supply amount of the cathode gas for the characteristic value referring to a preliminarily prepared correlation between an amount of the cathode gas supplied during performance of the reference operation and the characteristic value;
calculating, as an error in the measured amount of the cathode gas supplied to the fuel cell, a difference between the supply amount reference value and the measured amount of the cathode gas supplied to the fuel cell; and
adjusting the amount of the cathode gas supplied to the fuel cell such that the error in the measured amount of the cathode gas supplied to the fuel call is compensating for in supplying the cathode gas to the fuel cell, using a correction value that is calculated on the basis of the difference between the measured amount of the cathode gas and the acquired supply amount reference value.

7. (canceled)
